(19) United States
(12) Patent Application Publication
(10) Pub. No.: US 2016/0247100 A1
(43) Pub. Date: Aug. 25, 2016

(54) SELECTING AND ALLOCATING

(71) Applicant: HEWLETT PACKARD ENTERPRISE DEVELOPMENT LP, Houston, TX (US)

(72) Inventors: Filippo Balestrieri, Palo Alto, CA (US); Cipriano A. Santos, Palo Alto, CA (US); Lyle Harold Ramshaw, Palo Alto, CA (US); Fereydoon Safai, Palo Alto, CA (US)

(21) Appl. No.: 15/033,018

(22) PCT Filed: Nov. 15, 2013
(86) PCT No.: PCT/US2013/070409

§ 371 Date: Apr. 28, 2016

(51) Int. Cl. G06Q 10/06

(52) U.S. Cl. CPC G06Q 10/0631

(57) ABSTRACT

An example method for allocating resources among tasks is provided. The method includes defining each task from a group of tasks in relation to an outcome of the each task. The outcome of each task is associated with a plurality of dimensions with respect to which the outcome is evaluated. The method also includes determining a subgroup of tasks from the group of tasks based on the dimensions associated with the outcomes of the tasks and determining a utility level for each of the tasks in the subgroup by using a utility function. The method further includes identifying a solution for allocating the resources among the subgroup of tasks based on a comparison of the utility level of the tasks.

### BACKGROUND

Organizations, businesses, and individuals often have to select between numerous different alternatives when making financially related decisions. In many situations, the alternatives offered to these organizations, businesses and individuals are so many (e.g., potentially uncountable) that a decision maker may have a difficult time to select what is the alternative that best fits his or her needs. In such complex situations, computer implemented tools may assist decision makers with refining their preferences and selecting the best possible alternative from the large pool of solutions that are offered to them.

### BRIEF DESCRIPTION OF THE DRAWINGS

FIG. 1 is a schematic illustration of an example of a system for selecting a solution from a set of candidate solutions and for allocating resources among tasks in accordance with an implementation of the present disclosure.

FIG. 2 illustrates a flow chart showing an example of a method for allocating resources among tasks and for selecting a solution from a set of candidate solutions in accordance with an implementation of the present disclosure.

FIG. 3 illustrates a flow chart showing an example of a method for identifying a solution for allocating resources among a subgroup of tasks in accordance with an implementation of the present disclosure.

FIG. 4 illustrates a flow chart showing an example of a method for identifying a temporary best solution and a proposed temporary best solution for allocating resources in accordance with an implementation of the present disclosure.

FIGS. 5 and 5A illustrate a flow chart showing an example of a method for determining a final solution to select a task from a subgroup of tasks in accordance with an implementation of the present disclosure.

### DETAILED DESCRIPTION

As noted above, organizations, businesses, and individuals frequently have to select between a large number of different solutions or alternatives when they make financially related decisions. For example, there are many situations where decision makers must allocate a scarce resource (e.g., money, time, etc.) to different tasks (i.e., alternative courses of action) that may lead to different outcomes. Each of the possible solutions or tasks may be defined by different dimensions (e.g., goals or objectives) and may lead to a different outcome for the decision maker and/or the related business/organization.

Many times, manual comparison between all possible solutions or tasks available to a decision maker is unfeasible and very time consuming. This difficulty in selecting the best possible solution is due to the large number of possible alternatives, the specific dimensions defining the alternatives, internal rules and procedures the decision maker must follow, and his and her subjective preferences.

One example of such selection process is when a marketing manager for a corporation must allocate a specific amount of marketing funds among a large number of marketing campaigns (e.g., 50, 500, 1000, etc.). Each of these marketing campaigns may be defined by specific dimensions (i.e., goals or objectives, such as revenue, profit, etc.), where the outcome for each campaign may be identified or measured by one number (i.e., specific result or value) for each dimension (e.g., one monetary amount for revenue, one monetary amount for profit, etc.). In another example, a chief information officer (CIO) wants to select the best possible portfolio of available IT projects and there are several dimensions from which the portfolio can be defined or optimized, such as return on investment (ROI), direct or indirect benefit, customer satisfaction, technical alignment, etc.

A decision maker (e.g., marketing manager, CIO, etc.) thus needs to be able to refine his or her preferences when selecting between the various available solutions or tasks. It is often desirable for a decision maker to identify the most preferred alternative (i.e., the alternative that best fits his or her needs and provides the best outcome) from the set of multiple available alternatives.

In many situations, determining the most preferred task or solution from of the large number of alternatives may require going through all of the alternatives and analyzing their dimensions and outcomes manually. Alternatively, a scenario analysis tool that is less time consuming may be used. However, these tools only offer the possibility to compare a limited number of options that are arbitrary selected. The selected solution can be sub-optimal and with much lower level of decision accuracy because relevant options may be accidently neglected and the limited number of comparisons may prevent the decision maker from identifying his or her preferences in the best possible way.

Consequently, computer implemented tools and methods may assist decision makers with refining their preferences and selecting the best possible solution from the large pool of solutions that are offered to them. As noted above, each of the possible tasks or alternatives (e.g., marketing campaign, project portfolio planning) is associated with an outcome that is defined by different dimensions, where each of the dimensions may be measured by one numerical value. In a marketing campaign example, the dimensions (e.g., goals or objectives) may include profit, revenue, market share, etc. In a project portfolio management example, the dimensions may include ROI, customer satisfaction, project ranking, etc.

The present description is directed to systems, methods, and computer readable media for allocating resources among tasks and for selecting a solution from a set of candidate solutions (e.g., marketing campaigns, project portfolios, etc.). Specifically, the systems, methods, and computer readable media described herein propose evaluating the outcomes of the available solutions on the basis of the different dimensions associated with the outcomes of these solutions. The focus of the analysis is shifted to the dimensions (i.e., goals or objectives) that define each of the candidate solutions in the set. A set of proposed solutions is determined and an initial best task or solution is identified based on the utility associated to each solution. “Take-it-or-leave-it” offers are used to elicit the preferences of the decision maker over the available dimensions and to select the best solution for allocating resources.

Although there may be trade-offs between the dimensions for each solution, the evaluation of the dimensions and the “take-it-or-leave-it” offers are used to help the decision maker to resolve the differences that arise from comparing the various solutions. In many situations, there is not a single solution that maximizes all dimensions simultaneously, the decision maker may not know the complete set of candidate tasks or solutions, and he or she may not have pre-specified preferences over the full set of outcomes associated with the set of solutions. Considering these circumstances, the proposed methods and systems continually present different options to the decision maker to identify an allocation of resources (i.e., the most preferred alternative or task) that ranks as high as possible in the decision maker's latent preferences.

Thus, this novel and previously unforeseen approach allows decision makers quickly and efficiently to select from a large set of possible tasks or solutions. The approach is applicable to a large set of resource allocation problems and can be used in many different industries. The approach is very effective, imposes very light requirements on the decision makers and requires minimum input from them, which make it very attractive to users. The decision makers do not need to have ex-ante well defined preferences over the set of alternatives. Throughout the proposed process the decision maker is allowed to modify his or her initial preferences and adjust them in order to select a final best solution for allocation of resources.

An initial user input is used for determining a starting point, an initial temporary best solution that is later challenged/modified by a sequence of offers. Specifically, the proposed approach offers opportunity to improve on one or more of the dimensions associated with the solutions at a particular “trade-off cost” in terms of other dimensions (i.e., increase in value of one of the dimensions at the cost of decrease in value of another dimension). Depending on the degree of certainty of the decision maker on the initial preference over the output dimensions and his or her level of inflexibility in trading one dimension for another, the proposed approach can be particularly fast in determining a final solution to be selected. Even when the decision maker is uncertain about his or her preference and shows a high elasticity of substitution between the dimensions, the proposed method offers a systematic way to explore the different alternatives of the available tasks or solutions.

In an example implementation, a method for allocating resources among tasks is provided. As with other methods described in this disclosure, the method can be performed by a computing device. For instance, a non-transitory machine-readable storage medium may store one or more computer programs or modules, which when executed by the computing device cause the method to be performed. The method includes defining each task from a group of tasks in relation to an outcome of the each task. The outcome of each task is associated with a plurality of dimensions with respect to which the outcome is evaluated. The method also includes determining a subgroup of tasks from the group of tasks based on the dimensions associated with the outcomes of the tasks and determining a utility level for each of the tasks in the subgroup by using a utility function. The method further includes identifying a solution for allocating the resources among the subgroup of tasks based on a comparison of the utility level of the tasks.

In another example implementation, a system for selecting a solution from a set of candidate solutions is provided. The system includes at least one processor arid a memory resource coupled to the processor. The memory resource stores instructions to direct the at least one processor to identify an outcome for each solution from the set of candidate solutions, where the outcome of each solution is defined by “n” number of dimensions with respect to which the outcome is evaluated. The memory resource also stores instructions to direct the at least one processor to define each solution from the set of candidate solutions in relation to its outcome, determine a subset of solutions from the set of candidate solutions by comparing the “n” dimensions associated with the outcome of each of the solutions, and select a final solution based on a comparison of utility levels of the solutions in the subset of solutions, wherein a utility level for each solution is calculated with a utility function.

As used herein, the terms “task,” “solution,” and “alternative” may be used interchangeably and refer to a plurality of different options that are available to organizations, businesses and individuals and are presented to them for selection or allocation of resources. It is to be understood that the methods and techniques described below may be used in a wide variety of industries and systems and may help a decision maker to make a selection among any type of possible tasks or solutions (e.g., business alternatives, consumer products, software systems, portfolio of IT projects, etc.).

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

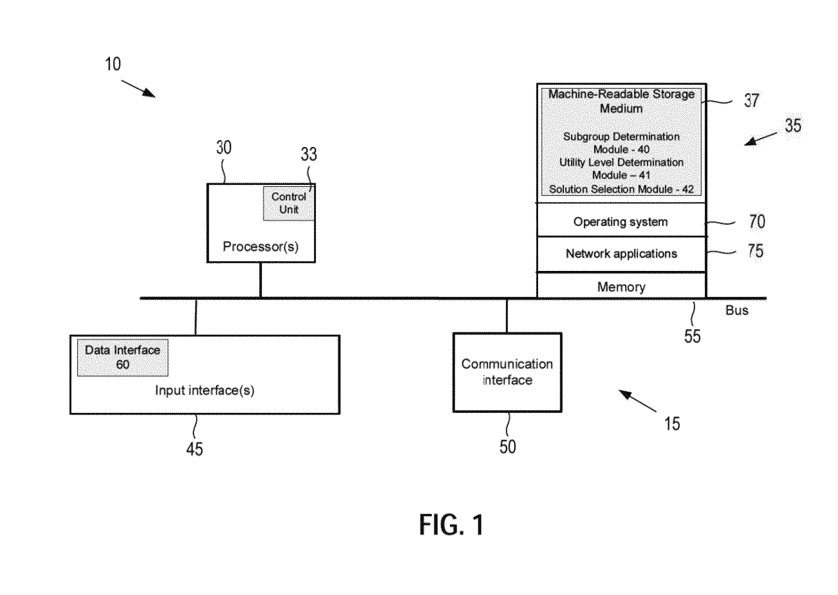

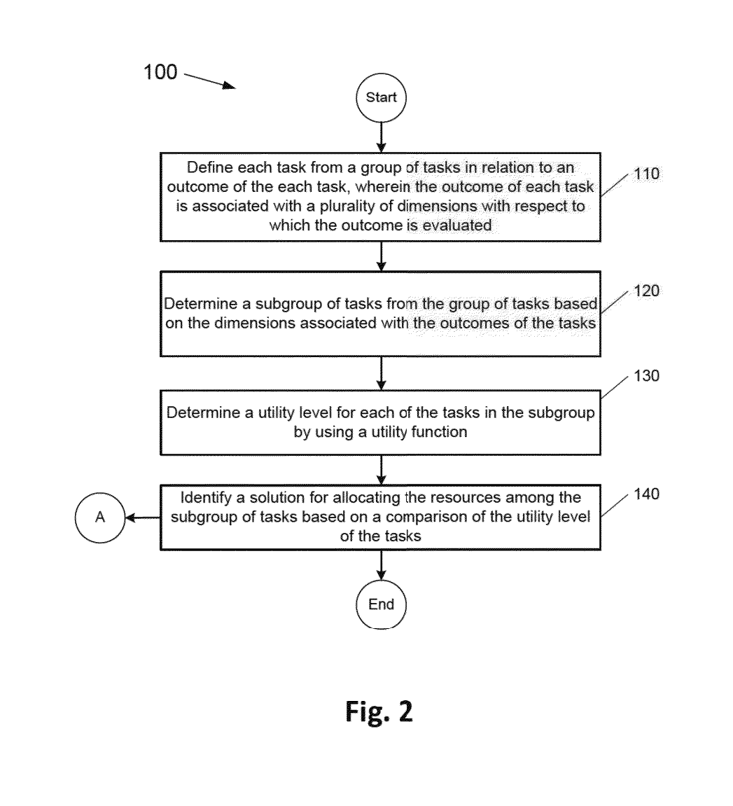

FIG. 1 is a schematic illustration of an example of a system 10 for selecting a solution from a set of candidate solutions and for allocating resources among tasks. The system 10 includes at least one computing device 15 capable of carrying out the techniques described below. The computing device 15 can be a personal computer, a laptop, a server, a mobile device, a plurality of distributed computing devices, or any other suitable computing device. In the illustrated example, the computing device 15 includes at least one processor 30, a memory resource 35, a communication interface 50, and input interface(s) 60.

As explained in additional detail below, the computing device 15 includes software, hardware, or a suitable combination thereof configured to enable functionality of the computing device 15 and to allow it to carry the techniques described below and to interact with the one or more external systems/devices. For example, the computing device 15 includes communication interfaces (e.g., a Wi-Fi® interface, a Bluetooth® interface, a 3G interface, a 4G interface, a near filed communication (NFC) interface, etc.) that are used to connect with external devices/systems (not shown) and/or to a network (not shown). The network may include any suitable type or configuration of network to allow for communication between the computing device 15 and any external devices/systems. It is to be understood that the operations described as being performed by the computing device 15 that are related to this description may, in some implementations, be performed by any other computing device.

The processor 30 (e.g., a central processing unit, a group of distributed processors, a microprocessor, a microcontroller, or another suitable programmable device), the memory resource 35, the input interfaces 45, and the communication interface 50 are operatively coupled to a bus 55. In other examples, the computing device 15 includes additional, fewer, or different components for carrying out similar functionality described herein.

The communication interface 50 enables the computing device 15 to communicate with a plurality of networks and communication links. The input interfaces 45 can receive information from any internal or external devices/systems in communication with the computing device 15. In one example, the input interfaces 45 include at least a data interface 60. In other examples, the input interfaces 45 can include additional interfaces. In one example, the data interface 60 receives information associated with a plurality of tasks or solutions that a user must evaluate and select from. For example, the data interface 60 can receive information regarding the outcome of each task or solution (e.g., a marketing campaign) that is associated with a plurality of dimensions (e.g., profit, revenue, market share, etc.) with respect to which the outcome is evaluated.

The processor 30 includes a controller 33 (also called a control unit) and may be implemented using any suitable type of processing system where at least one processor executes computer-readable instructions stored in the memory 35. The memory resource 35 includes any suitable type, number, and configuration of volatile or non-transitory machine-readable storage media 37 to store instructions and data. Examples of machine-readable storage media 37 in the memory 35 include read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, an SD card, and other suitable magnetic, optical, physical, or electronic memory devices. The memory 35 may also be used for storing temporary variables or other intermediate information during execution of instructions to be executed by processor 30.

The memory 35 may also store an operating system 70 and network applications 75. The operating system 70 can be multi-user, multiprocessing, multitasking, multithreading, and real-time. The operating system 70 can also perform basic tasks such as recognizing input from input devices, such as a keyboard, a keypad, or a mouse; sending output to a projector and a camera; keeping track of files and directories on memory 35; controlling peripheral devices, such as printers, image capture device; and managing traffic on the bus 55. The network applications 75 include various components for establishing and maintaining network connections, such as computer-readable instructions for implementing communication protocols including TCP/IP, HTTP, Ethernet, USB, and FireWire.

Software stored on the non-transitory machine-readable storage media 37 and executed by the processor 30 includes, for example, firmware, applications, program data, filters, rules, program modules, and other executable instructions. The control unit 33 retrieves from the machine-readable storage media 37 and executes, among other things, instructions related to the control processes and methods described herein. In one example, the instructions stored in the non-transitory machine-readable storage media 37 implement a subgroup determination module 40, a utility level determination module 41, and a solution selection module 42. In other examples, the instructions can implement more or fewer modules (e.g., various other modules related to the operation of the system 10).

As explained in additional detail below, the subgroup determination module 40 determines a subgroup of tasks or solutions from an initial group of tasks based on the dimensions associated with the outcomes of the tasks. The utility level determination module 41 determines a utility level for each of the tasks or solutions in the subgroup by using a utility function. Further, the solution selection module 42 identifies or selects a solution for allocating the resources among the subgroup of tasks based on a comparison of the utility level of the tasks.

Information and data associated with the system 10 and other systems/devices can be stored, logged, processed, and analyzed to implement the control methods and processes described herein. For example, the memory 35 may include at least one database (not shown) that is internal to the computing device 15. In other implementations, a database may be stored remotely of the computing device 15. In one example, information about the outcome of each task or solution and the plurality of dimensions associated with the outcome can be stored in the database.

As noted earlier, selection between a large number of different task or solutions is a frequent problem for many decision makers. The issue of what is the best way to allocate a scarce resource (e.g., money, time, etc.) among a plurality of tasks or solutions that have different outcomes is critical to many individuals and organizations.

Manual comparison between all available solutions or tasks is very Lime consuming. Thus, a decision maker needs to efficiently refine his or her preferences in order to identify the most preferred solution from the set of available tasks or solutions. For instance, when a marketing manager must decide how to allocate a predetermined amount of marketing funds among a large number of marketing campaigns, she needs to be able to quickly sort through the available options and define which campaign best fits the needs of the company and/or her personal preferences. In that situation, each campaign has a different outcome (i.e., produces specific rewards) that is defined by dimensions (e.g., profit, revenue, market share, etc.). The outcome for each campaign may be measured with one value (i.e., number) for each dimension (e.g., one monetary amount for revenue, one monetary amount for profit, etc.).

The techniques described below propose evaluating the outcomes of the available tasks or solutions on the basis of the different dimensions associated with these outcomes, identifying an initial best solution or task based on a utility level for each solution, and further refining the solutions by a series of “take-it-or-leave-it” offers that are used to align the preferences of the decision maker over the available dimensions. The choices between the different solutions or tasks are presented in terms of a choice between preferences across the dimensions with respect to which the outcome associated with each of the solutions is evaluated. At the end, a final solution is selected or a task for allocating the resources is identified by the decision maker.

FIG. 2 illustrates a flow chart showing an example of a method 100 for allocating resources among tasks and for selecting a solution from a set of candidate solutions. In one example, the method 100 can be executed by the control unit 33 of the processor 30 of the computing device 15. Various steps described herein with respect to the method 100 are capable of being executed simultaneously, in parallel, or in an order that differs from the illustrated serial manner of execution. The method 100 is also capable of being executed using additional or fewer steps than are shown in the illustrated examples.

The method 100 may be executed in the form of instructions encoded on a non-transitory machine-readable storage medium 37 executable by processor 30 of the computing device 15. In one example, the instructions for the method 100 implement the subgroup determination module 40, the utility level determination module 41, and the solution selection module 42.

The method 100 begins at step 110, where the control unit 33 defines each task or solution from a group of tasks in relation to its outcome. As noted above, in one example, the outcome of each task is associated with a plurality of dimensions with respect to which the outcome is evaluated. In the example described above, the tasks or solutions may be a group of marketing campaigns, where each campaign has a different outcome that is defined by a plurality of dimensions (e.g., revenue, profit, market share, etc.). In other words, each of the marketing campaigns produces an outcome that is defined by the specific dimensions (e.g., campaign A produces +3% increase in revenue, +1% increase in profit, and +2% increase market share; campaign B produces +1% increase in revenue, +3% increase in profit, and +1% increase market share, etc.). Therefore, the outcome for each task includes a value (e.g., a single number) for each dimension associated with the outcome from the task.

In one example, an initial set of feasible tasks or solutions (i.e., marketing campaigns) is predefined and is available to the decision maker for selection and/or allocation. The values for the dimensions associated with each task or solution are also predefined. Given some specific constraints (e.g. at most a level “x” of resource can be allocated to task “A”), a set of feasible tasks or solutions that satisfy all constraints is identified. This identification of tasks or solutions can be completed by the decision maker, her manager, another person in the organization, a third party, or in any other suitable way. The predetermined set of tasks or solutions may be stored in a database of the computing device 15, in an external database, in the cloud, etc. Considering the example above, a group or a set of all possible combinations of marketing campaigns that satisfy some constraints and can be possibly funded with the resources (e.g., $100) is identified (e.g., first solution—one campaign in the U.S. that costs $100; second solution—2 campaigns that each cost $50, one in France and one in Spain, etc.). The number and nature of the tasks and their dimensions may be industry specific. Dimensions can vary depending on the type of assets being allocated, the objectives, and the overall goal of the allocation project. The tasks or solutions may be products, services, projects, or anything that may conceivably be a subject to choices or preferences associated with the decision maker.

Thus, the control unit 33 defines or maps each task or solution from the group of predetermined tasks into the “space” of outcomes. In other words, the outcome for each task or solution is identified, where the outcome is defined by the “n” number of dimensions with respect to which the outcome is evaluated. In one implementation, the number “n” is at least two. In other words, the outcome for each task or solution is associated with at least two dimensions. Therefore, each of the tasks is defined in terms of its outcome that includes specific values for each dimension (e.g., campaign A produces +3% increase in revenue, +1% increase in profit, and +2% increase market share).

Next, at step 120, the control unit 33 determines a subgroup of tasks or solutions from the predetermined group of tasks or solutions based on the dimensions associated with the outcomes of the tasks. In other words, the control unit determines a subset of the tasks or solutions by comparing the “n” dimensions associated with the outcome of each of the solutions. This can be done by the subgroup determination module 40. In one example, the control unit 33 classifies the tasks or solutions as dominated and dominating tasks and identifies a Pareto efficient subgroup of tasks or solution for further analysis. In another example, different properties of the tasks or solutions (in addition to or alternatively to Pareto efficiency) may be used to classify the tasks or solutions and to determine a subset.

Various methods can be used to identify a Pareto efficient subset of tasks or solutions from the initial predetermined group of tasks or solutions. In one example, a Pareto dominated task is defined as a task where the control unit can identify another task from the initial group of tasks that is superior with respect to all dimensions associated with the outcome of the first task. In the example above, there may be three possible tasks—campaign A that produces +3% increase in revenue, +1% increase in profit, and +2% increase market share; campaign B that produces +1% increase in revenue, +3% increase in profit, and +1% increase market share; and campaign C that produces +0.5% increase in revenue, +0.5% increase in profit, and +0.5% increase market share. In that example, campaign C is Pareto dominated, whereas campaigns A and B are both Pareto dominating (i.e., none of them is dominated and they both will be included in the Pareto efficient set).

In another implementation, a task or solution is Pareto-dominating, if, given a specific value for n−1 dimensions, the outcome of the task is the one with the maximum value for the n-th dimension. In other words, it is impossible to determine an outcome (i.e., another task) with a higher value on the n-th dimension without incurring a lower value for some of the n−1 other dimensions. In the example with campaigns A and B, the value for the revenue may be fixed at +3% and the value for market share may be fixed at +2% (i.e., these are the n−1 dimensions). The control unit 33 determines what is the task or solution from the predefined group of tasks that has the highest value of profit such that the revenue is at least +3% and the revenue is at least +2%. According to the described example, campaign A is Pareto dominating because the revenue in campaign B is equal to +3% (which is greater than the +1% of revenue in campaign A), but the profit in campaign B is less than 3% and the market share is less than 2%. Thus, campaign A is not dominated by campaign B. Similar, campaign B is not dominated by campaign A, and, therefore, both campaigns are Pareto dominating. Thus, the control unit defines dominating and dominated solutions among the group of candidate solutions and eliminates the dominated solutions to define the subset of solutions. The end result of step 120 is a subgroup or subset of Pareto dominating tasks that satisfy all constraints of the predetermined set and are identified based on the dimensions associated with the outcomes of the initial group of tasks.

With continued reference to FIG. 2, the control unit 33 determines a utility level for each of the tasks in the subgroup by using a utility function (at step 130). For example, this is done by the utility level determination module 41. In one implementation, the control unit 33 uses the utility function described below to represent the preferences of the decision maker related to the specific dimensions of the tasks during the selection process and to identify a task or solution among the subgroup of tasks for allocating the resources. Specifically, the control unit 33 uses the utility function to determine the level of utility for each of the tasks or solutions in the subgroup of tasks or solutions. In one example, the utility function is represented as:

$$U = {[ {{a}_{1} ( {k}_{1} {x}_{1} )}^{s} + {{a}_{2} ( {k}_{2} {x}_{2} )}^{s} + … + {{a}_{n} ( {k}_{n} {x}_{n} )}^{s} ]}^{\frac{1}{s}}$$

where U represents the utility of each task or solution, each parameter xᵢ corresponds to the value that an output of a task receives with respect to the i-th dimension from the plurality of dimensions; the parameters aᵢ and kᵢ include values representing the relative importance of a dimension i with respect to the other dimensions associated with the outcome of the task; and the parameter s is associated with the elasticity of substitution value

$$σ = \frac{1}{1 - s}$$

that measures the degree of flexibility with which a user (i.e., the decision maker) is willing to exchange a gain in at least one dimension with a loss in at least one different dimension to maximize the utility by selecting a different task or solution. In one example, Σᵢαi=1.

For example, if the dimensions associated with the outcomes from the tasks are: x₁—revenue; x₂—profit; x₃—market share, the values for the xᵢ parameter correspond to the values of these dimensions (e.g., if task A increases x₁ with 1%, the value inputted in the utility function is 0.01, etc.). The values for parameters aᵢ and kᵢ that represent the relative importance of a dimension i with respect to the other dimensions may be received from the decision maker. The decision maker is asked to provide a degree of relative importance of the different dimensions associated with the outcome. In one implementation, the relative importance of the dimensions can be obtained by asking the decision maker to distribute a budget (e.g., one dollar) over the n different dimensions (e.g., x₁=$0.50; x₂=$0.25; x₃=$0.25).

Alternatively, the decision maker may rank the n dimensions by placing numbers 1−n of relative importance of the dimensions (e.g., x₁=1; x₂=2; x₃=3, where 1 is the highest or most important ranking number). In another example, default or predetermined values for the relative importance of the dimensions may be used (e.g., when the decision maker does not provide any direct input). In other words, the method 100 does not require a specific way to represent the ranking of the dimensions by the decision maker. In yet another example, the value of the dimensions ranked by the decision maker may be represented as a relative proportion between the different dimensions. For instance, if x₁=$0.50; x₂=$0.25; x₃=$0.25, then in the utility function: a(1)=a(2)=a(3)=1, and k(1)=2, k(2)=k(3)=1; or alternatively a(1)=k(1)=2, a(2)=k(2)=1, a(3)=k(3)=1.

The received set of numbers for the relative importance of the dimensions is transferred into an appropriate set of values for aᵢ and kᵢ to be included in the specification of the utility function. In one implementation, the decision maker may not update the values for relative importance of the dimensions by entering new numbers during the selection process. As explained in additional details below, the parameters aᵢ and kᵢ are automatically updated by the control unit 33 during the execution of the method 100 based on the user's selection. In other words, the parameters aᵢ and kᵢ may be continuously recalculated if a user selects a task or solution that is different (i.e., has different dimension values) than a previously offered task or solution. Therefore, the initial values for the parameters aᵢ and kᵢ may not be critical to the final selection of a task or a solution because these values may change based on the user's selections.

In one implementation, all dimensions (e.g., x₁, x₂, and x₃) may be considered equally important to the decision maker (e.g., all dimensions are ranked with 1). In that situation,

$${a}_{i} = \frac{1}{n}$$

and kᵢ=1 for any i (i.e., the decision maker considers market share to be as important as revenue). In one example, each value xᵢ may be transformed into its corresponding percentage change by comparing xᵢ to the status quo

$$\frac{{x}_{i} - {x}_{i} *}{{x}_{i} *}$$

for any dimension i, where the status quo level xⱼ* represents a value for any dimension i during a previous time frame (e.g., the previous fiscal year). These transformed values of xᵢ are then used for calculation in the function. When using the transformed values of xᵢ, the values of parameters aᵢ and kᵢ are chosen with respect to the transformed value of xⱼ.

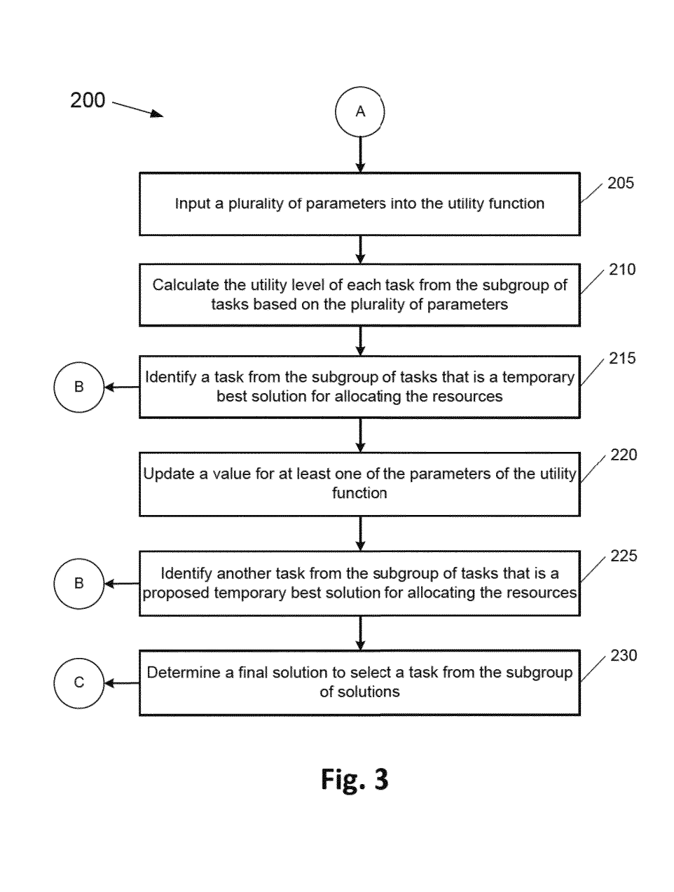

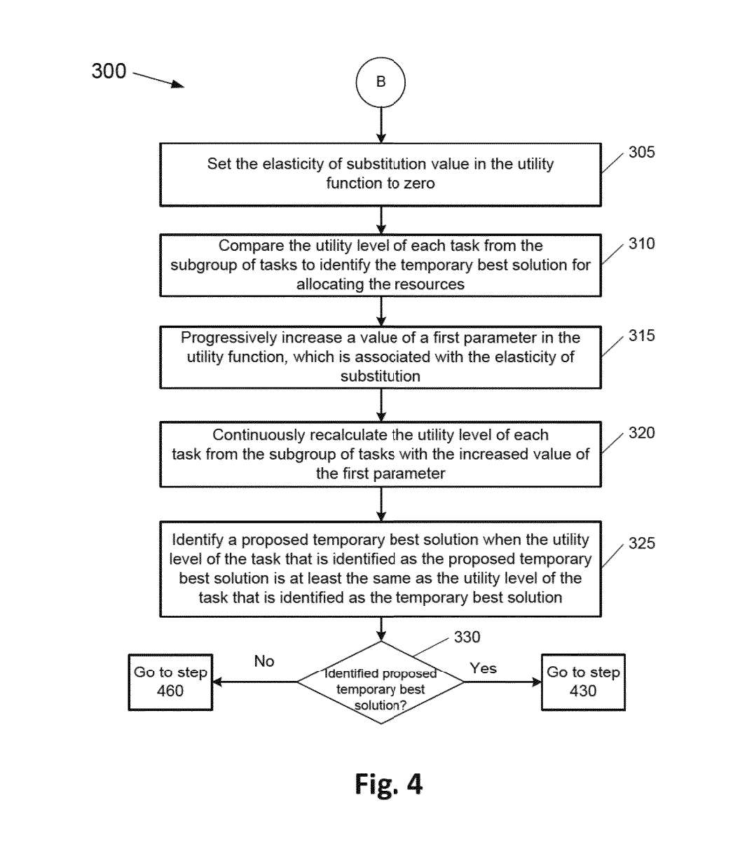

With continued reference to FIG. 2, the control unit 33 identifies a solution for allocating the resources among the subgroup of tasks based on a comparison of the utility level of the tasks (at step 140). For example, this is done by the solution selection module 42. As explained in additional details below with relation to FIGS. 3 and 4, all the parameters described above are inputted into the utility function to calculate the utility level U of each task from the subgroup of tasks. The utility level U of these tasks is used to allocate the available resource among the tasks (i.e., to select a solution from the plurality of candidate solutions).

FIG. 3 illustrates a flow chart showing an example of a method 200 for identifying a solution for allocating the resources among a subgroup of tasks (i.e., for selecting a solution from the plurality of candidate solutions). In one example, the method 200 can be executed by the control unit 33 of the processor of the computing device 15. Various steps described herein with respect to the method 200 are capable of being executed simultaneously, in parallel, or in an order that differs from the illustrated serial manner of execution. The method 200 is also capable of being executed using additional or fewer steps than are shown in the illustrated examples.

The method 200 may be executed in the form of instructions encoded on a non-transitory machine-readable storage medium 37 executable by a processor 30 of the computing device 15. In one example, the instructions for the method 200 implement the utility level determination module 41 and the solution selection module 42.

The method 200 begins at step 205, where the plurality of parameters are inputted into the utility function. As explained above, these parameters include values for the dimensions associated with each task (i.e., xᵢ), values representing a relative importance of the dimensions (i.e., aᵢ and kᵢ), and the elasticity of substitution value s that represents a degree of flexibility with which a user is willing to trade one dimension with another. In one example, the values for these parameters are inputted in the utility function by the control unit 33. In other examples, the values for these parameters may be imputed by a user.

Next, at step 210, the control unit 33 calculates the utility level U of each task from the subgroup of tasks based on the plurality of parameters inputted into the utility function. In one example, the utility level U of each task or solution is represented by a numerical value. The specific process of calculation of the utility level U by using the described parameters will be explained in relation to FIG. 4 that shows the process for determining a temporary best solution and a proposed temporary best solution.

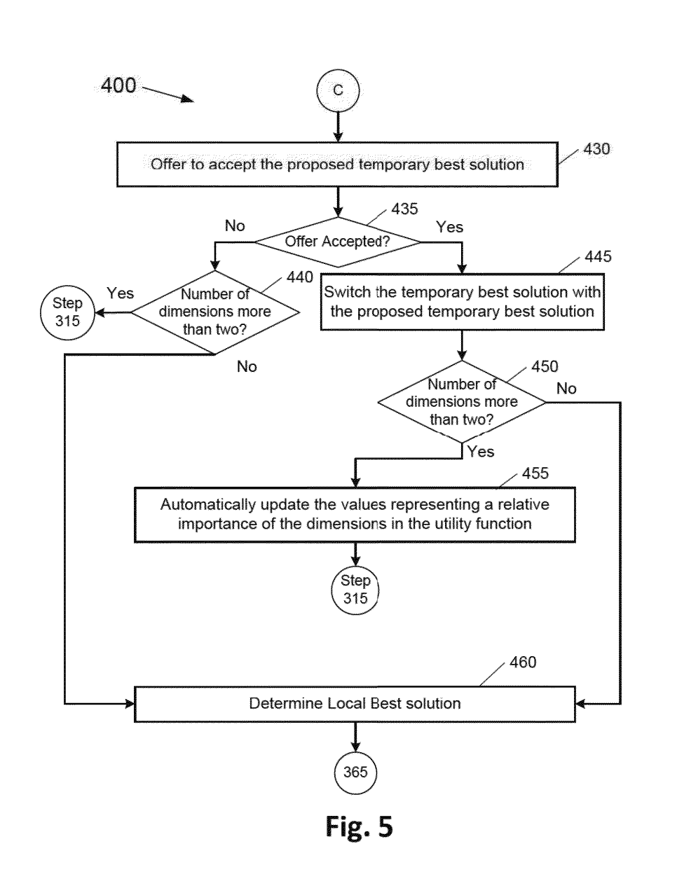

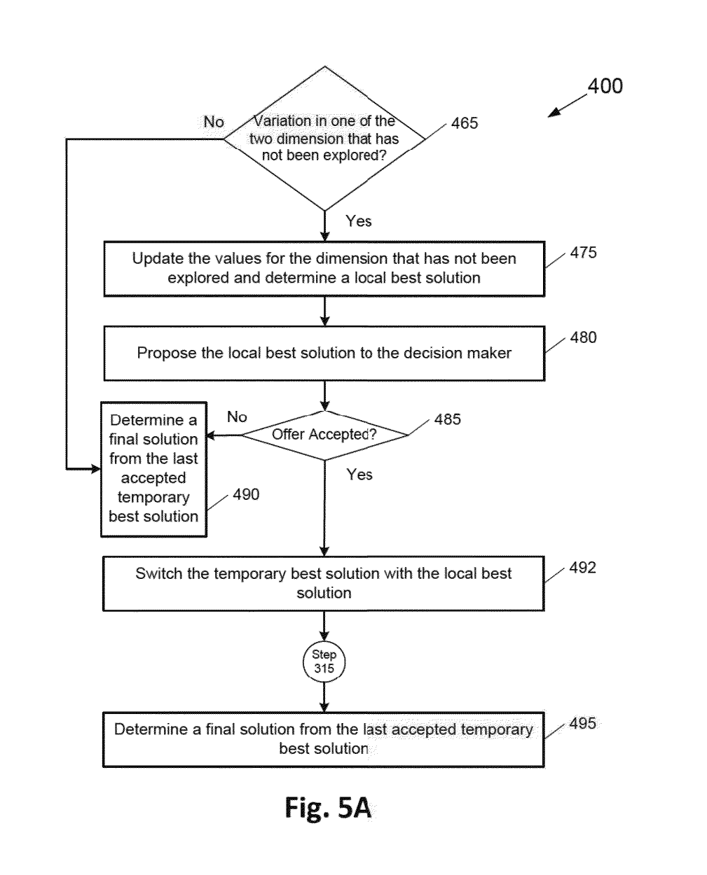

At step 215, the control 33 unit identifies a task from the subgroup of tasks that is a temporary best solution for allocating the resources. The control unit then updates a value for at least one of the parameters of the utility function (at step 220). As explained in additional details below, the control unit 33 progressively increases the elasticity of substitution value s. At step 225, the control unit identifies another task from the subgroup of tasks that is a proposed temporary best solution for allocating the resources. Finally, the control unit 33 determines a final solution to select a task from the subgroup of solutions or tasks (at step 230). That process is explained in additional detail in relation to FIGS. 5 and 5A.

FIG. 4 illustrates a flow chart showing an example of a method 300 for identifying a temporary best solution and a proposed temporary best solution for allocating the resources. In one example, the method 300 can be executed by the control unit 33 in the form of instructions encoded on a non-transitory machine-readable storage medium 37. In one example, the instructions for the method 300 implement the solution selection module 42.

The method 300 begins at step 305, where the control unit 33 sets the elasticity of substitution value in the utility function to zero (i.e., σ=0) by setting the value of the parameter s in the utility function to minus infinity (i.e. s→−∞). In other words, the user has no elasticity of substitution and he or she is not willing to substitute any of the values associated to the different dimensions in the function. For example, loss of 1% in revenue cannot be compensated by increase in the other dimensions (e.g., profit or market share). The control unit 33 calculates the utility level U for each of the tasks or solutions based on the elasticity of substitution that is equal to zero.

Then, the control unit 33 compares the utility level U of each task from the subgroup of tasks/solutions to identify the temporary best solution for allocating the resources (at step 310). In one example, the task or solution with the highest utility level U is identified as the temporary best solution. This is the first task or solution from the subset of tasks or solutions that may be offered to the decision maker as the final solution to select a task from the subgroup of tasks. Next, the control unit 33 progressively increases the value of the parameter s, which is associated with the elasticity of substitution in the utility function (at step 315). In one example, the value of s may progressively increase until it reaches 1 (e.g., −100,000, −50,000, −10,000, −500, −5, etc.).

The control unit 33 continuously recalculates the utility level U of each of the tasks or solutions from the subgroups of tasks with the increased value of the parameter s (at step 320). The control unit 33 then identifies a proposed temporary best solution when the utility level of the task that is identified as the proposed temporary best solution is at least the same as the utility level of the task that is identified as the temporary best solution (at step 325). In other words, given the initial set of parameters and preferences by the use and the increased elasticity of substitution value s, the control unit 33 determines if there is another task or solution from the subset of tasks or solutions that has at least the same (or higher) utility level U as the previously identified temporary best solution.

That new task or solution is identified as a proposed temporary best solution. In some examples, the proposed temporary best solution includes dimensions with values that are different (i.e., higher or lower) from the values of the dimensions in the temporary best solution (e.g., revenue is +3% where in the temporary best solution revenue is +1%). In other implementations, the task associated with the temporary best solution identified at step 310 may be the best possible solution based on the values of the parameters inputted into the utility function. In that situation, even when the values of the parameter s associated with elasticity of substitution is increased (e.g., until it reaches 1), the control unit 33 may not identify a proposed temporary best solution and may proceed to identifying a local best solution (explained in additional details below).

At step 330, the control unit determines if a proposed temporary best solution is identified. If such proposed temporary best solution is identified, the control unit proceeds with step 430 of a method 400 for determining a final solution to select a task from a subgroup of tasks (described in additional details below). If no temporary best solution is identified to challenge the standing temporary best solution (i.e., when the task associated with the temporary best solution identified at step 310 is selected as the best possible solution), the control unit 33 directly proceeds with step 460 of the method 400 to determine a local best solution (also described in additional details below).

FIGS. 5 and 5A illustrate a flow chart showing an example of a method 400 for determining a final solution to select a task from a subgroup of tasks. When a proposed temporary best solution is identified (at step 325), the control unit 33 offers to the decision maker to switch from the previously identified temporary best solution and to accept the proposed temporary best solution (at step 430). In one example, the control unit displays a message on a display screen (not shown) of the computing device 15 or another computing device operated by the user. Other suitable methods for communicating the offer to the decision maker may also be used. In one implementation, the control unit 33 shows the differences between the proposed temporary best solution and the previously identified temporary best solution (e.g., the differences with respect to each dimension (i.e., gain/loss) that are associated with switching from one task or solution to another).

The decision maker may either reject or accept the offer to switch from the previously identified temporary best solution to the proposed temporary best solution. Alternatively, the user may also stop or exit the process 400 at any time (the step is not shown in FIGS. 5 and 5A). In that situation, the standing or most recent temporary best solution becomes a final solution to select a task from a subgroup of tasks. The user can provide his or her response by using an input device (e.g., a keyboard, a voice activate input, etc.) or any other suitable way of providing a response to the control unit 33. In step 435, the control unit 33 determines what is the user's response regarding the offer. If the user rejects the offer, the control unit determines whether the number of dimensions associated with the evaluated outcomes is more than two (at step 440). If the number of dimensions is more than two, the control unit returns to step 315 where it progressively increases the value of the parameter s, which is associated with the elasticity of substitution in the utility function, in order to identify a new proposed temporary best solution. This may be repeated until no new proposed temporary best solution is identified to challenge the standing temporary best solution. In that case, the control unit proceeds to step 460 to determine a local best solution (described in additional details below). Alternatively, if the number of dimensions is two, the control unit directly proceeds to step 460 to determine a local best solution.

If the user accepts the offer, the control unit 33 switches the temporary best solution with the proposed temporary best solution (at step 445). In that case, the proposed temporary best solution becomes a new temporary best solution. The acceptance of the proposed temporary best solution that has a different set of dimensions represents the user's actual ranking of the importance of the dimensions and his willingness to substitute the dimensions in the solutions. That selection helps the method to further clarify what is the best possible solution.

Next, the control unit 33 determines whether the number of dimensions associated with the evaluated outcomes is more than two (at step 450). If the number of dimensions is two, the control unit proceeds to step 460 to determine a local best solution. If the number of dimensions is more than two, the control unit may automatically update the values aᵢ and kᵢ representing relative importance of the dimensions in the utility function (at step 455). In one example, the values for kᵢ are updated to correspond to the relative importance dimensions in the new temporary best solution and the values of aᵢ are also adjusted to keep aᵢkᵢ=1/n for any i.

Therefore, the proposed method adjusts the values representing the relative importance of the dimensions based on the user's response and refines the user's preferences based on the user's selection. That way, the initial use rankings and values for aᵢ and kᵢ that represent the relative importance of the dimensions are not significant because they may be adjusted accordingly based on the user's response. After the values for aᵢ and kᵢ are modified in the utility function, the control unit 33 returns to step 315 where it continues to progressively increase the value of parameter s (which is associated with the elasticity of substitution in the utility function) in order to try to identify a new proposed temporary best solution (e.g., the elasticity of substitution value is increased until the value reaches 1 or a final offer is selected). Steps 320, 325, and 330 may also be repeated after step 315. That way, the control unit 33 may continue to offer new proposed temporary best solutions for the user's consideration in order to best identify the user's preferences and to help the user to select the best possible task or solution from the subgroup of solutions. The process described in steps 430, 435, 445, 450, 455, and 315-330 is repeated until no new proposed temporary best solution is identified to challenge the standing temporary best solution. When such stage is reached (i.e., when the task associated with the temporary best solution identified at step 310 is selected as the best possible solution), the control unit 33 proceeds to step 460 to determine a local best solution.

When the analyzed tasks and their outcomes include only two dimensions, the control unit determines a local best solution that is offered to the decision maker. Because only two dimensions (e.g., revenue and profit) are involved in the outcome, the substitutability between dimensions is much faster to check. In one example, the identified initial temporary best solution generates 5% of revenue and 3% of profit, and after the increase of the elasticity of substitution value s, the proposed temporary best solution generates 3% revenue, 4% profit. If the user rejects the proposal to switch to the proposed temporary best solution the control unit determines that there is no point in offering new solutions with revenue lower than 5% because any other proposed temporary best solution of this kind would offer worst terms of trades in the exchange of revenue for profit (i.e., more profit for much less revenue; for example 1% of revenue and 4.5% of profit).

Therefore, at step 465, the control unit 33 determines whether there are variations in one of the two dimensions (e.g., revenue) that has not been explored or changed that may identify new proposed temporary solutions. If there are no variations in the unexplored dimension that may identify new proposed temporary solutions, the control unit identifies the final solution to select a task as the last accepted temporary best solution (at step 490). Alternatively, if there are some variations in the unexplored dimension that may identify new proposed temporary solutions that were not already offered, the control unit updates the values for the dimension that has not been explored and determines a local best solution (at step 475). In some implementations, the control unit 33 only makes minor updates in the dimensions, which lead to new solutions that are in the “neighborhood” of the temporary best solution. Considering the example from the preceding paragraph, it does that by identifying the solution that offers the highest increase in revenue with the lowest decrease in profit. For example a proposed local best solution may offer 5.5% of revenue and 2.5% of profit. The differences between the local best solution and the temporary best solution (e.g., gain/loss of dimension, etc.) may he displayed for the user.

The control unit then proposes the identified local best solution to the decision maker (at step 480). The decision maker may either reject or accept the offer to switch from the temporary best solution to the local best solution. In step 485, the control unit 33 determines what is the user's response regarding the offer. If the user rejects the offer, the control unit identifies the final solution to select a task as the last accepted temporary best solution (at step 490). If the user accepts the offer, the control unit 33 switches the temporary best solution with the local best solution (at step 492). In that case, the local best solution becomes a new temporary best solution. Then, the control unit 33 returns to step 315 where it continues to progressively increase the value of the parameter s (which is associated with the elasticity of substitution in the utility function) in order to identify a new proposed temporary best solution until the elasticity of substitution value is increased until the value reaches 1 or a final offer is selected. The new values for aᵢ and kᵢ also change the utility level that is calculated with the utility function. The process described in steps 465-492 is repeated until no new proposed temporary and local best solution is identified and the last temporary best solution accepted by the user is identified as the final solution (at step 495) to select a task or solution from the subgroup of tasks.

1. A method for allocating resources among tasks, the method comprising:
defining, with a computing device, each task from a group of tasks in relation to an outcome of the each task, wherein the outcome of each task is associated with a plurality of dimensions with respect to which the outcome is evaluated;
determining, with the computing device, a subgroup of tasks from the group of tasks based on the dimensions associated with the outcomes of the tasks;
determining, with the computing device, a utility level for each of the tasks in the subgroup by using a utility function; and
identifying, with the computing device, a solution for allocating the resources among the subgroup of tasks based on a comparison of the utility level of the tasks.

2. The method of claim 1, wherein the outcome for each task includes a value for each dimension associated with the outcome from the task.

3. The method of claim 1, wherein identifying a solution for allocating the resources among the subgroup of tasks comprises:
inputting, with the computing device, a plurality of parameters into the utility function,
calculating, with the computing device, the utility level of each task from the subgroup of tasks based on the plurality of parameters,
identifying, with the computing device, a task from the subgroup of tasks that is a temporary best solution for allocating the resources,
updating, with the computing device, a value for at least one of the parameters of the utility function,
identifying, with the computing device, another task from the subgroup of tasks that is a proposed temporary best solution for allocating the resources, and
determining, with the computing device, a final solution to select a task from the subgroup of tasks.

4. The method of claim 3, wherein the plurality of parameters comprise values for the dimensions associated with each task, values representing a relative importance of the dimensions, and a first parameter associated with an elasticity of substitution value that represents a degree of flexibility with which a user is willing to exchange a gain in at least one dimension with a loss in at least one different dimension, wherein the values representing the relative importance of the dimensions can be inputted from the user or can be predetermined values.

5. The method of claim 4, wherein determining the temporary best solution and the proposed temporary best solution for allocating the resources comprises:
setting, with the computing device, the elasticity of substitution value in the utility function to zero,
comparing, with the computing device, the utility level of each task from the subgroup of tasks to identify the temporary best solution for allocating the resources,
progressively increasing, with the computing device, a value of the first parameter in the utility function,
continuously recalculating, with the computing device, the utility level of each task from the subgroup of tasks with the increased value of the first parameter, and
identifying, with the computing device, the proposed temporary best solution when the utility level of the task that is identified as the proposed temporary best solution is at least the same as the utility level of the task that is identified as the temporary best solution.

6. The method of claim 5, wherein identifying a solution for allocating the resources among the subgroup of tasks further comprises:
offering, with the computing device, to accept the proposed temporary best solution,
rejecting, with the computing device, the proposed temporary best solution,
accepting, with the computing device, the proposed temporary best solution,
switching, with the computing device, the temporary best solution with the proposed temporary best solution when the offer to accept the proposed temporary best solution is accepted, and
determining, with the computing device, a final solution to select a task from the subgroup of tasks.

7. The method of claim 6, further comprising automatically updating, with the computing device, the values representing relative importance of the dimensions in the utility function when the temporary best solution is switched with the proposed temporary best solution.

8. The method of claim 6, wherein identifying a solution for allocating the resources among the subgroup of tasks further comprises:
determining, with the computing device, a local best solution when at least one of the dimensions in the utility function was not modified,
offering, with the computing device, to accept the proposed local best solution,
rejecting, with the computing device, the local best solution,
accepting, with the computing device, the local best solution,
switching, with the computing device, the temporary best solution with the local best solution when the offer to accept the local best solution is accepted, and
determining, with the computing device, a final solution to select a task from the subgroup of tasks.

9. A system for selecting a solution from a set of candidate solutions, the system comprising:
at least one processor; and
a memory resource coupled to the at least one processor and storing instructions to direct the at least one processor to:
identify an outcome for each solution from the set of candidate solutions, where the outcome of each solution is defined by “n” number of dimensions with respect to which the outcome is evaluated,
define each solution from the set of candidate solutions in relation to its outcome,
determine a subset of solutions from the set of candidate solutions by comparing the “n” dimensions associated with the outcome of each of the solutions, and
select a final solution based on a comparison of utility levels of the solutions in the subset of solutions, wherein a utility level for each solution is calculated with a utility function.

10. The system of claim 9, wherein the memory resource further stores instructions to direct the at least one processor to:
input a plurality of parameters into the utility function, wherein the plurality of parameters comprise values for the “n” dimensions associated with each solution, values representing a relative importance of the dimensions, and a first parameter associated with an elasticity of substitution value that represents a degree of flexibility with which a user is willing to exchange a gain in at least one dimension with a loss in at least one different dimension,
calculate the utility level of each solution from the subset of solutions by using the plurality of parameters,
compare the utility level of each solution from the subset of solutions to identify a temporary best solution, where the temporary best solution initially has an elasticity of substitution value of zero,
progressively increase the value of the first parameter associated with the elasticity of substitution value in the utility function, and
continuously recalculate the utility level of each solution from the subset of solutions with the increased value of the first parameter to identify a proposed temporary best solution.

11. The system of claim 10, wherein the memory resource further stores instructions to direct the at least one the processor to:
propose to substitute the temporary best solution with the proposed temporary best solution,
reject the proposed temporary best solution when the proposal is not accepted,
accept the proposed temporary best solution when the proposal is accepted,
substitute the temporary best solution with the proposed temporary best solution, and
determine the final solution to select from the subset of solutions.

12. The system of claim 9, wherein the memory resource further stores instructions to direct the at least one processor to define dominating and dominated solutions among the group of candidate solutions and eliminate the dominated solutions to define the subset of solutions.

13. A non-transitory machine-readable storage medium encoded with instructions executable by at least one processor of a system for allocating resources among tasks, the machine-readable storage medium comprising instructions to:
define each task from a group of tasks in relation to an outcome of the each task, wherein the outcome of each task is associated with “n” number of dimensions with respect to which the outcome is evaluated and the outcome includes a value for each of the “n” dimensions;
determine a subgroup of tasks from the group of tasks by comparing the “n” dimensions associated with the outcomes of the tasks;
use a utility function to calculate a utility level for each of the tasks in the subgroup of tasks; and
identify a solution for allocating the resources among the subgroup of tasks by comparing the utility level of the tasks.

14. The non-transitory machine-readable medium of claim 13, further comprising instructions to:
calculate the utility level of each task from the subgroup of tasks by using a plurality of parameters inputted into the utility function, wherein the plurality of parameters comprise values for the “n” dimensions associated with each task, values representing a relative importance of the “n” dimensions, and a first parameter associated with an elasticity of substitution value that represents a degree of flexibility with which a user is willing to exchange a gain in at least one dimension with a loss in at least one different dimension,
set the elasticity of substitution value to zero and compare the utility level of each task from the subgroup of tasks to identify a task that is a temporary best solution for allocating the resources,
progressively increase a value of the first parameter in the utility function, and
continuously recalculate the utility level of each task from the subgroup of tasks with the increased value of the first parameter to identify a task that is a proposed temporary best solution and has a utility level that is at least the same as the utility level of the task that is identified as the temporary best solution.

15. The non-transitory computer-readable medium of claim 14, further comprising instructions to:
offer to accept the proposed temporary best solution,
reject the proposed temporary best solution,
accept the proposed temporary best solution,
replace the temporary best solution with the proposed temporary best solution when the offer to accept the proposed temporary best solution is accepted,
automatically update the values representing a relative importance of the “n” dimensions in the utility function when the temporary best solution is replaced with the proposed temporary best solution, and
determine a final solution to select a task from the subgroup of tasks.
